(19) United States
(12) Patent Application Publication
(10) Pub. No.: US 2008/0094254 A1
(43) Pub. Date: Apr. 24, 2008

(54) Pedestrian warning system

(75) Inventor: John P. Hill, Hazel Park, MI (US)

Correspondence Address: FOLEY AND LARDNER LLP;SUITE 500, 3000 K STREET NW, WASHINGTON, DC, 20007, US

(73) Assignee: TK HOLDINGS INC.

(21) Appl. No.: 11/905,987

(22) Filed: Oct. 5, 2007

Related U.S. Application Data
(60) Provisional application No. 60/828,315, filed on Oct. 5, 2006.

(51) Int. Cl. G08B 21/02

(52) U.S. Cl. 340/944

(57) ABSTRACT

A pedestrian warning system includes an ultrasonic emitter provided on a vehicle configured to emit an ultrasonic signal and configured to create a shaped ultrasonic field. The ultrasonic emitter may be configured to generate a sonic signal to warn pedestrians in a specific area that the vehicle is approaching.

### CROSS REFERENCE TO RELATED APPLICATIONS

The present application claims priority to and the benefit of U.S. Provisional Patent Application No. 60/828,315 filed Oct. 5, 2006. The aforementioned provisional application is incorporated by reference herein in its entirety.

### BACKGROUND

The present application relates generally to the field of automobile safety. Specifically, the present application is directed to systems and methods for providing an ultrasonic field having a warning area generating a compressed wave (i.e., a sound wave) to warn pedestrians of pending dangers.

In large metropolitan areas, there are numerous people passing in front of and behind vehicles. Unfortunately, sometimes people get in the way of a moving vehicle and are injured. A conventional warning system consists of a horn which a driver manually activates to warn pedestrians that a vehicle is approaching and to get out of the way. One obvious drawback to this conventional warning system is that the driver has to notice the pedestrian first, and then the driver has to blow the horn. Thus, if the driver does not see the pedestrian, whether from the front or the rear, then the warning system is ineffective. Another drawback with this conventional warning system is that once the system is activated, not only does the pedestrian in danger hear the alarming sound, but many other pedestrians, including pedestrian not even in the vicinity of the vehicle, hear the same alarming sound. As one knows, this can be quite annoying in large metropolitan areas with many vehicles and pedestrians.

In view of the foregoing, there exists various needs in the art. One such need is for a virtual horn pedestrian warning system in the form of an ultrasonic field having a warning area to warn pedestrians of pending dangers. Another need is a virtual horn pedestrian warning system in the form of an ultrasonic field which is created by a single emitter or multiple emitters with the shape of the warning area being determined by the number of emitters and the emitted ultrasonic field.

### SUMMARY

According to one disclosed embodiment, a virtual horn pedestrian warning system includes at least two ultrasonic emitters provided on a vehicle configured to emit ultrasonic signals, having different frequencies, and configured to create a shaped ultrasonic field. The ultrasonic emitters are further configured to cause the ultrasonic signals to interfere with each other to generate a sonic signal to warn pedestrians in a specific area that the vehicle is approaching.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a block diagram of the components of a state of the art conventional loudspeaker system.

FIG. 2 is a block diagram of the components of a compression wave generation system used with the virtual horn pedestrian warning system.

FIG. 3 is an illustration of the new compression wave generation using the apparatus of FIG. 2.

FIG. 4 is a block diagram of the components of an alternative compression wave generation system used with a virtual horn pedestrian warning system.

FIG. 5 is a block diagram of the components of an alternative compression wave generation system used with a virtual horn pedestrian warning system.

FIG. 6 is an alternative embodiment of the compression wave generation system according to the embodiment illustrated in FIG. 5.

FIG. 7 is an embodiment which discloses reflection of the ultrasonic frequency signals to develop acoustical effects.

FIG. 8 illustrates a virtual horn pedestrian warning system.

FIG. 9 illustrates an alternative embodiment of the virtual horn pedestrian warning system.

FIG. 10 illustrates a further alternative embodiment of the virtual horn pedestrian warning system.

### DETAILED DESCRIPTION

Embodiments will be described below with reference to the accompanying drawings. It should be understood that the following description is intended to describe exemplary embodiments of the invention, and not to limit the invention.

By projecting two ultrasonic tones with a frequency difference of an audible frequency, a pedestrian would hear the audible tone whenever they were in a specific area where both ultrasonic tones were present. Hence, whenever a pedestrian enters an area just in front of a vehicle, they would hear a warning tone indicating caution is prudent. Alternatively, whenever a pedestrian enters an area just behind a vehicle, they would hear a warning tone indicating that the vehicle is backing up.

A shaped ultrasonic field is used to warn the pedestrian of an approaching vehicle. By way of example only, the ultrasonic field could be created by a single emitter or by multiple emitters. The shape of the warning area could be controlled by the number of emitters and the shape of the emitted ultrasonic field. The emitters may be located at basically same point or may be separated.

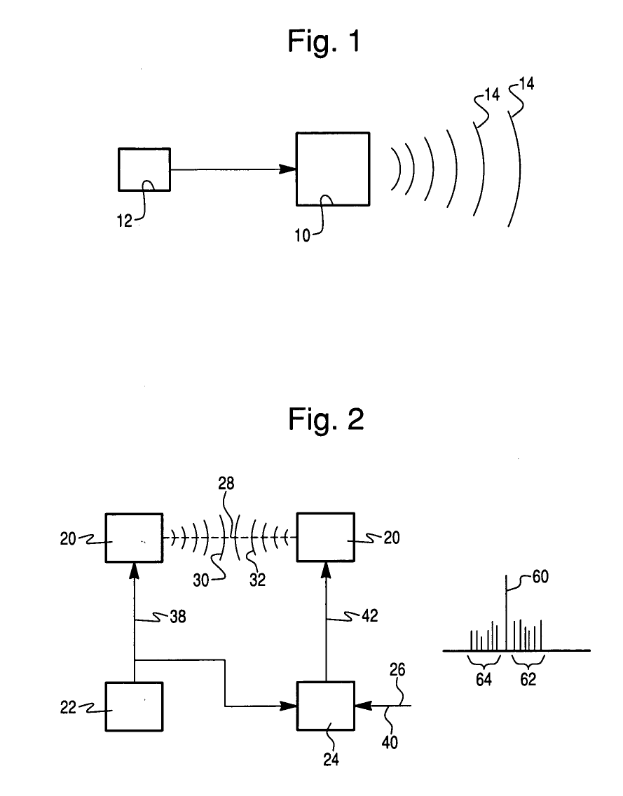

A direct process for the creation of compression waves is defined as causing a radiating element 10 to vibrate at a desired frequency as shown in FIG. 1. The system of FIG. 1 is typically used to directly generate audible and inaudible compression waves, both above and below the range of human hearing. A conventional compression wave generating system includes a speaker element 10 which can be any dynamic, electrostatic or other direct radiating element, and a signal source such as a signal generator or amplifier 12. The signal source 12 supplies an electrical signal representative of a compression wave having a specific frequency or frequencies at which the speaker element 10 will vibrate to produce compression waves 14.

Before proceeding further, it will be helpful to define several terms to be used hereinafter. A “signal source” will interchangeably refer to a “signal generator” or “amplifier” which provides electrical signals representative of compression waves to be emitted from a speaker. The term “speaker” will interchangeably refer to the terms “horn”, “transducer”, “emitter”, “loudspeaker”, “diaphragm”, “physical radiating element” or “direct radiating element” which converts the electrical signals to a mechanical vibration causing compression waves. The term “compression wave” will interchangeably refer to the terms “tone” “sound wave”, “longitudinal wave” and “wave train” which are sonic, subsonic and ultrasonic waves propagating through a transmission medium such as air.

In a preferred embodiment a method and apparatus for generating a new compression wave is disclosed. Compression wave generation is accomplished as illustrated in FIG. 2. The fundamental elements of the system include at least two ultrasonic acoustical transducers 20, an ultrasonic signal source 22, a signal combiner 24 that combines signals, and an input 26 to the signal combiner 24 which provides a signal to be superimposed upon a carrier signal. The ultrasonic signal source 22 also functions as a controller that controls the frequency of signals being emitted from the at least two ultrasonic acoustical transducers 20. The dotted line 28 indicates that the orientation of the transducers 20 are coaxial. The acoustical transducers 20 are designed to emit compression waves at ultrasonic frequencies.

The signal combiner 24 performs the function of modifying one or both of the ultrasonic wave trains 30, 32 being generated by the ultrasonic signal source 22. The signal combiner 24 combines a first ultrasonic signal 38 with an electrical-signal 40, representing the new compression wave 42 to be generated. The combination is defined as the sum of the first ultrasonic signal 38 and the desired compression wave 42 and is transmitted as the second ultrasonic signal 42.

The method of combining signals 38 and 40 is accomplished through amplitude modulation. For example purposes only, the signal combiner 24 can be an amplitude modulator. FIG. 2 further illustrates that amplitude modulation creates a signal having a fundamental frequency 60, an upper sideband 62, and a lower sideband 64. The upper sideband 62 is used because it represents a non-inverted signal which carries the information that will become the new compression wave.

The apparatus above is able to function as described because the compression waves 30, 32 interfere in air (or in the ear of a listener). The waves combine, interfere or overlap. At certain times the waves may coincide and the peaks (or maxima) of the compression waves add, at other points the a positive peak of one wave may coincide with a negative peak of another wave causing the two waves to cancel each other. The listener is able to detect the change in peak through movement of the ear cilia. The combination or interference of the waves is described in Section 21-3 of University Physics (8^{th} Ed.) by Hugh D. Young, Addison Wesley Publishing Company, Copyright 1992 (incorporated by reference herein). The ability to product directional waves is improved when the when both fundamental waves are ultrasonic, thus generally above 20 KHz.

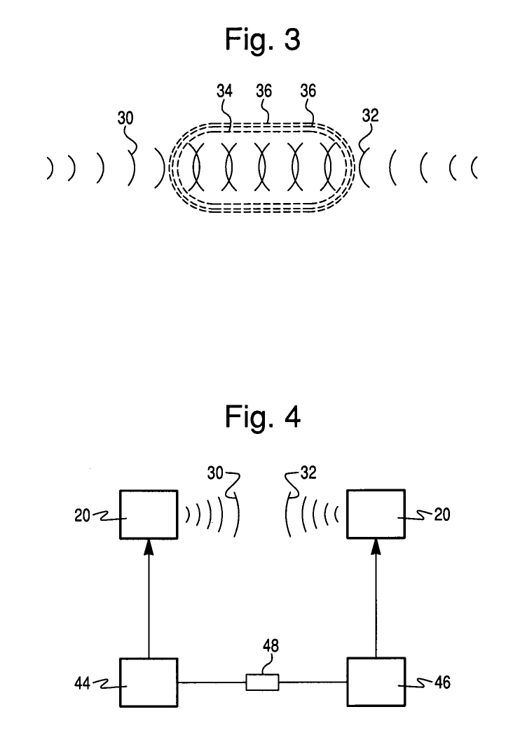

The preferred transmission medium is air because it is a highly compressible medium. FIG. 3 illustrates that the generation of a new compression wave is made possible by two ultrasonic wave trains 30, 32 that interfere. The combining of the two compression waves may result in wave sonic or subsonic, and is shown as a compression wave 36 which is emitted generally omni-directionally from the region of interference 34. The shape of the new wave is generally dictated by the shape of the region of interference 34 and may be called the shaped ultrasonic field. In this illustration, the region 34 will be generally cylindrical as would be seen if drawn in three dimensions. The shape of the region 34 can, however, be modified to produce a desired effect. Furthermore, the illustration of opposing and generally coaxial compression waves 30, 32 should not be thought to depict the only orientation that the waves can have.

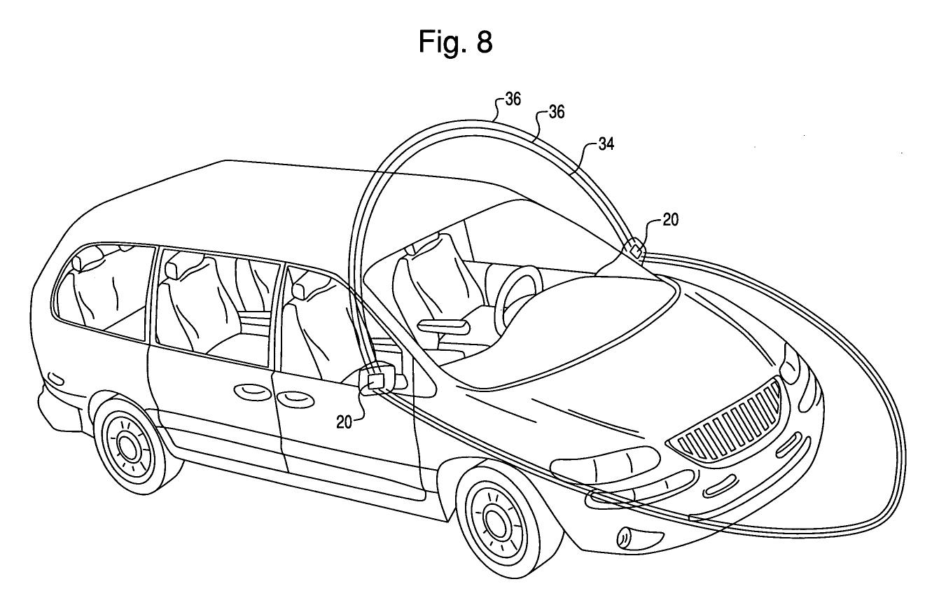

Referring now to FIG. 8, which illustrates an exemplary embodiment of a virtual horn pedestrian warning system, the system utilizes the compression wave generation system incorporated on an automobile. As illustrated, the two ultrasonic acoustical transducers 20 are provided on the outside of the vehicle, for example, but the transducers 20 may be provided on the inside of the vehicle. The acoustical transducers 20 are designed to emit compression waves at ultrasonic frequencies. The acoustical transducers 20 create an ultrasonic field which includes the two ultrasonic waves 30, 32 and a resulting compressed wave 36 (which defines the warning area). A pedestrian is able to hear audible tones defined by the compressed wave 36 within the warning area. Examples of transducers 20 can be piezoelectric or electrostatic devices, but may obviously include other radiating elements for the appropriate frequency range. The other system components can be located inside the vehicle to protect these elements from the outside environment. The ultrasonic signal sources 22 communicates with internal system components of the vehicle to create the ultrasonic signal.

As illustrate in FIG. 8, the ultrasonic acoustical transducers 20 are provided on the side view mirrors of the vehicle. Alternatively, the ultrasonic acoustical transducers 20 may be provided on the hood or the grill or other parts of the vehicle in order to create the ultrasonic field. The warning area is an unsafe area of the vehicle that someone enters and can hear the resulting compressed wave 36 (i.e., the warning sound). According to an exemplary embodiment, the compressed wave 36 is emitted generally omni-directionally from the region of the region of interference 34. In general, the shape of the warning area is controlled by the number of acoustical transducers 20 and the shape of the emitted ultrasonic field. Although two acoustical transducers are shown in the figure, more than two acoustical transducers can be provided on the vehicle to create the desired shape of the ultrasonic field which in turn will help to create the desired shape of the waiting area. For example, the waiting area can be designed such that a majority of people can hear the audible sound taking into consideration the various heights of people in general.

According to an exemplary embodiment, the components of the virtual horn pedestrian warning system are powered by the vehicle's electrical system, for example, the vehicle's alternator while the vehicle is in motion. The warning sound can be any sound that would alert a pedestrian that he is in an unsafe area. Various sounds include a horn sound, a buzzer, a computerized voice sound, etc.

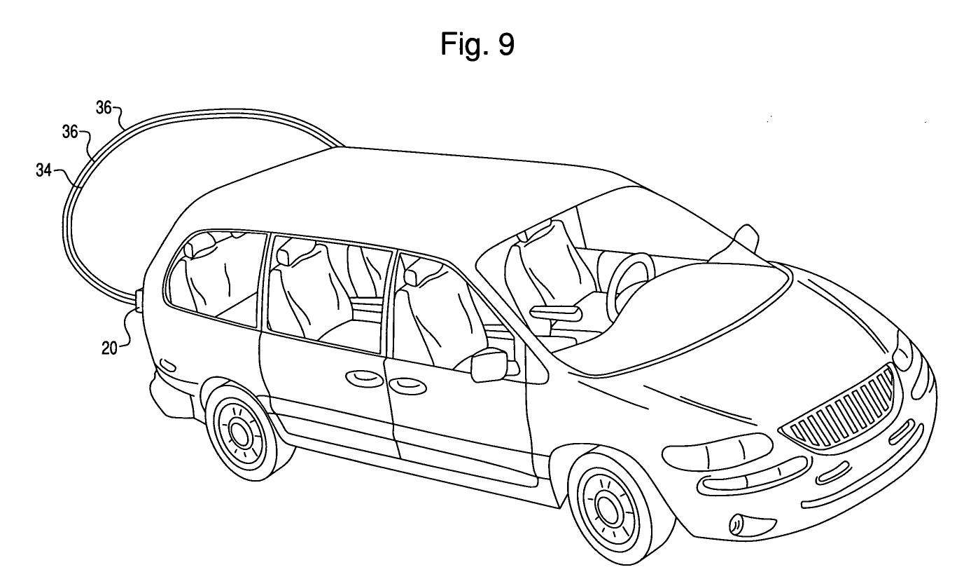

As illustrated in FIG. 9, an alternative embodiment of the virtual horn pedestrian warning system may have the ultrasonic acoustical transducers 20 placed at the rear of the vehicle. According to this embodiment, a pedestrian can we warned that the vehicle is moving in the reverse direction.

While FIG. 2 illustrates the use of a single ultrasonic signal source 22, it should be realized that it is possible to provide separately generated electrical signals to the ultrasonic transducers 20. FIG. 4 illustrates using two separate ultrasonic signal sources 44, 46. The risk of this configuration is that frequency drift becomes a possibility. Thus, a synchronization between the two ultrasonic signal sources 44, 46 may be provided. For example, a synchronizing controller 48 might coordinate emission of the two ultrasonic frequency signals 30, 32.

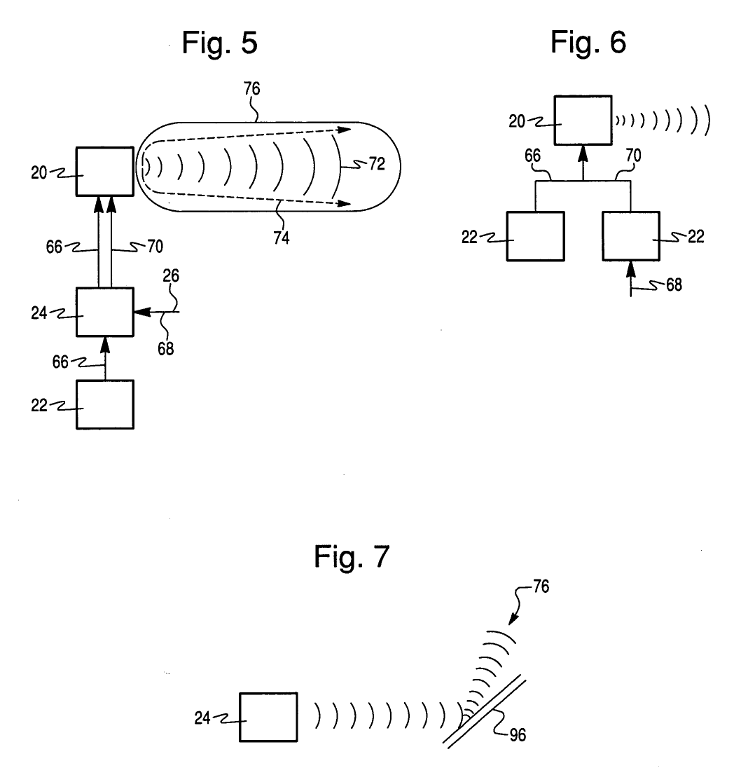

FIG. 5 is a block diagram of the components of an alternative compression wave generation system used with an embodiment of the virtual horn pedestrian warning system. In a comparison with FIG. 2, a significant difference is the elimination of one ultrasonic transducer 20. Otherwise, the remaining ultrasonic transducer 20, the signal combiner 24 and the ultrasonic signal source 22 remain substantially the same. First, the electrical signals involved are the first ultrasonic signal 66 which is the fundamental wave, and the electrical signal 68 which represents the new sonic or subsonic wave to be combined with the ultrasonic signal 66. The combination of the signals 66, 68 creates a new electrical signal 70 composite as a new upper sideband that is the sum of signals 66 and 68, along with signal 66, both of which are emitted from the ultrasonic transducer 20 as a compression wave 76.

A pedestrian will hear the new compression wave 76 from a region of interference 74 which generally can begin at a transmitting face of the ultrasonic transducer 20. Except for the audible evidence to the contrary, this might lead one to incorrectly conclude that the ultrasonic transducer 20 is generating the new compression wave 76.

FIG. 6 is an alternative embodiment of the compression wave generation system according to the embodiment illustrated in FIG. 5. FIG. 6 more intuitively illustrates the two distinct ultrasonic compression waves 66 and 70 being transmitted to the ultrasonic transducer 20 for emission therefrom. Separate ultrasonic signals sources 22 are shown for each of the ultrasonic compression waves in FIG. 6.

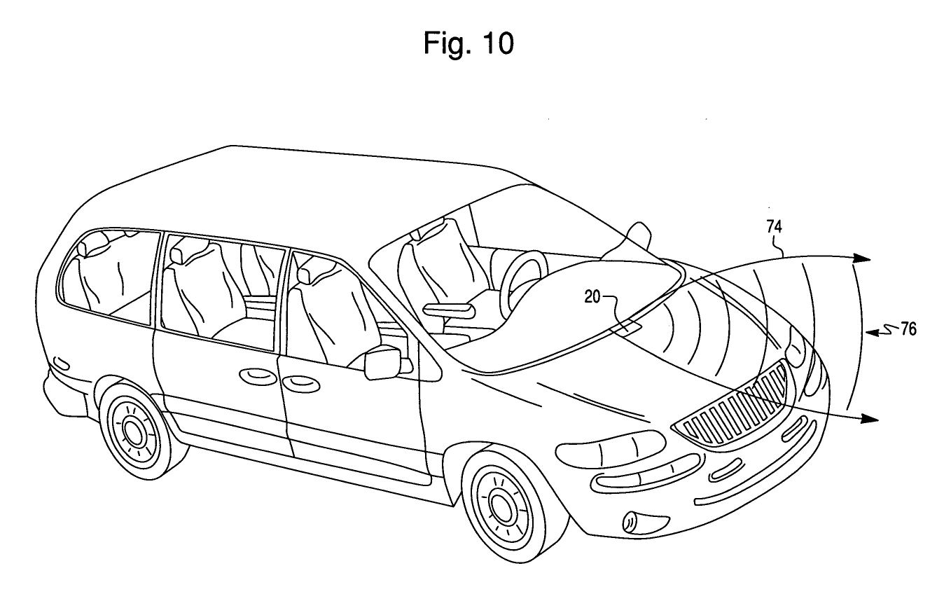

FIG. 10 illustrates a further alternative embodiment of the virtual horn pedestrian warning system. As illustrated in FIG. 10, the compression wave system illustrate in FIG. 6 is integrated onto the vehicle. As illustrated, the ultrasonic transducer 20 is provided on the hood of the vehicle approximately in the center. The resulting compression wave 76 provides a warning area to the pedestrian passing in front of the vehicle. The shape of the compression wave 76 can be modified to cover a wider or narrower regions so that only the pedestrian in an unsafe zone of the vehicle hears the warning signal.

FIG. 7 is an embodiment which teaches reflection of the ultrasonic frequency signals to develop acoustical effects. As illustrated in FIG. 7, a variety of acoustical effects can be simulated including three dimensional sound. By simply directing the orientation of the ultrasonic transducer 20 toward a ceiling or wall 96, one can simulate the experience of sound emanating from that location. If the transducer target is placed in motion, the moving reflective location creates an impression of movement for the sound or object being represented. Thus, according to an exemplary embodiment, the wall 96 can be placed on the vehicle in the vicinity of the ultrasonic transducer 20 to better direct the compression wave 76 in the direction of a pedestrian in the unsafe zone.

A consequence of the improved system disclosed herein is the generation of a new omni-directional compression wave. Specifically, the new compression wave will generally radiate outward omni-directionally from a region of interference, generally in accordance with the shape of the region.

The emitters described above may be controlled by a separate controller. The controller may be integrated into the vehicle's safety system and receive input from various vehicle sensors and the like. For example, the emitters may be regulated to operate during vehicle operating conditions. For example, the emitters may be automatically deactivated when the vehicle is parked or stopped.

The foregoing description of preferred embodiments of the invention has been presented for purposes of illustration and description. It is not intended to be exhaustive or to limit the invention to the precise form disclosed, and modifications and variations are possible in light of the above teaching or may be acquired from practice of the invention. The embodiments were chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. A pedestrian warning system, comprising:
at least two ultrasonic emitters provided on a vehicle configured to emit ultrasonic signals, having different frequencies, and configured to create a shaped ultrasonic field,
wherein the ultrasonic emitters are further configured to cause the ultrasonic signals to interfere with each other to generate a sonic signal to warn pedestrians in a specific area that the vehicle is approaching.

2. The pedestrian warning system according to claim 1, wherein the ultrasonic emitters are powered by electrical circuitry of the vehicle.

3. The pedestrian warning system according to claim 1, wherein the specific area is in front of the vehicle.

4. The pedestrian warning system according to claim 1, wherein the specific area is behind the vehicle.

5. The pedestrian warning system according to claim 1, wherein the operation of the emitters are controlled by a control module.

6. The pedestrian warning system according to claim 1, wherein the shaped ultrasonic field has a cylindrical shape.

7. The pedestrian warning system according to claim 1, further comprising a barrier placed near the ultrasonic emitters to direct the sonic signal.

8. The pedestrian warning system according to claim 1, wherein the sonic signal is emitted in one direction.

9. The pedestrian warning system according to claim 1, wherein the ultrasonic emitters are place inside the vehicle.

10. The pedestrian warning system according to claim 1, wherein the ultrasonic emitters are placed outside of the vehicle.

11. A pedestrian warning system, comprising:
an ultrasonic signal source configured to generate at least two ultrasonic signals;
a signal modulator configured to modify at least one of the signals from the ultrasonic signal source to create at least two different ultrasonic signals and
at least one ultrasonic emitter provided on a region of a vehicle configured to emit the ultrasonic signals and configured to create a shaped ultrasonic field,
wherein the at least one ultrasonic emitter is configured to cause the ultrasonic signals to interfere with each other to generate a sonic signal to warn pedestrians in a specific area that the vehicle is approaching.

12. The pedestrian warning system according to claim 11, further comprising a generator configured to generate an electrical signal, wherein the signal modulator is configured to modulate the at least one of the ultrasonic signals with the electrical signal.

13. The pedestrian warning system according to claim 12, wherein the at least one ultrasonic emitter, the ultrasonic signal source, the electrical signal generator and the signal modulator are powered by electrical circuitry of the vehicle.

14. The pedestrian warning system according to claim 11, wherein the specific area is in front of the vehicle.

15. The pedestrian warning system according to claim 11, wherein the specific area is behind the vehicle.

16. The pedestrian warning system according to claim 12, wherein the signal modulator is configured to modulate the at least one of the ultrasonic signals with the electrical signal using amplitude modulation.

17. The pedestrian warning system according to claim 11, wherein the at least one ultrasonic emitter causes the ultrasonic signals to interfere.

18. The pedestrian warning system according to claim 11, wherein the shaped ultrasonic field has a cylindrical shape.

19. The pedestrian warning system according to claim 11, further comprising a barrier placed near the ultrasonic emitter to direct the sonic signal.

20. A method for automatically generating a warning sound, comprising:
generating two ultrasonic signals having different frequencies;
providing at least two ultrasonic emitters on a vehicle to emit the ultrasonic signals; and
positioning the at least two ultrasonic emitters on the vehicle to create a shaped ultrasonic field and to cause the ultrasonic signals to interfere with each other to generate a sonic signal to warn pedestrians in a specific area that the vehicle is approaching.
